(19) United States
(12) Patent Application Publication
(10) Pub. No.: US 2006/0151556 A1
(43) Pub. Date: Jul. 13, 2006

(54) Cargo carrier

(76) Inventors: Dan C. Eby, Jasper, IN (US); Ray C. Niehaus, Santa Claus, IN (US)

Correspondence Address: Gary K. Price, Esq.;Bowers Harrison, LLP, 25 N.W. Riverside Drive, P.O. Box 1287, Evansville, IN, 47706-1287, US

(21) Appl. No.: 11/327,861

(22) Filed: Jan. 9, 2006

Related U.S. Application Data
(60) Provisional application No. 60/642,590, filed on Jan. 11, 2005.

(51) Int. Cl. B60R 9/00; B60R 11/00

(52) U.S. Cl. 224/519; 224/525

(57) ABSTRACT

A cargo carrier for storing and transporting luggage, gear and equipment and the like on the exterior of a vehicle. The cargo carrier includes a rectangular-shaped frame, a support member attached to the underside of the frame, support legs situated at each corner of the frame, a pin bracket attached to a front end of the frame, the pin bracket includes a bracket end that defines a pin bracket clearance. The bracket end extends in parallel relationship with front end of the frame and, the pin bracket clearance is in approximate alignment with a side aperture disposed on an engaging portion of the support member. The cargo carrier further includes an elongated hitch pin having a handle portion and a length so that the hitch pin passes through the pin bracket clearance of the pin bracket and into the side aperture of the engaging portion of the support member.

### CROSS REFERENCES TO RELATED APPLICATIONS

U.S. Provisional Application for Patent No. 60/642,590, filed Jan. 11, 2005, with title “Cargo Carrier” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention relates generally to a vehicle storage apparatus, and more particularly to a cargo carrier assembly for a cargo or equipment carrier that is attached to the exterior of a vehicle. The cargo carrier of this invention is particularly useful when attached to a standard tow or trailer hitch of the vehicle.

2. Brief Description of Prior Art

Various devices have been used and/or proposed to carry cargo or equipment on the exterior of a vehicle. Some known cargo carriers are trailers having one or more wheels which bear a substantial portion of the weight of the load carried by the carrier. Other cargo carriers include a rack or platform attached to one or more portions of the vehicle, such as a trailer hitch, the vehicle body or the vehicle bumper. Several carriers are known in which a member extends from the platform portion of the carrier to the vehicle's trailer hitch. The member telescopically engages and is attached to the trailer hitch.

Although the known cargo carriers generally function adequately for their intended purposes, these known devices have significant limitations and shortcomings. The known carriers are of relatively complex structure and are thereby rendered relatively expensive to assemble and for attachment to a vehicle. Moreover, known cargo carriers can be difficult to manage with respect to the vehicle. For example, it is often difficult with known cargo carriers to access where the carrier attaches with the vehicle's towing hitch without being required to lay on the ground surface beneath the carrier and/or vehicle in order to access connecting the carrier to the hitch. This practice is both dirty and obviously dangerous for the user beneath the carrier and/or vehicle. Also, prior art carriers are often required to be manually lifted when connecting or separating with the vehicle. This generally requires a minimum of two persons to manage the carrier.

As will be seen from the subsequent description, the preferred embodiments of the present invention, the present invention overcomes this and other shortcomings of the prior art.

### SUMMARY OF THE INVENTION

The present invention is a cargo carrier for storing and transporting luggage, gear, equipment and the like on the exterior of a vehicle. The cargo carrier is easily attachable to the vehicle. The cargo carrier of the present invention is engageable with a conventional trailer hitch tongue. The cargo carrier includes a frame having a platform, a supporting leg situated at each of the four corners of the frame, and detachable engagement means for attaching the cargo carrier to the vehicle's trailer hitch. Also preferably, a weather storage unit is detachably carried on the platform of the carrier, and is large enough to receive one or more pieces of luggage or other cargo therein.

The legs of the cargo carrier are selectively positioned while the cargo carrier is still connected to the vehicle so that the carrier can be stationed on the ground surface while still being connected to the vehicle. The engagement means of the present invention allows the user to connect or disconnect the cargo carrier to the vehicle's trailer hitch from an end of the cargo carrier, and avoids the user from being required to lie on the ground surface beneath the cargo carrier and/or vehicle to access where the cargo carrier attaches with the vehicle's towing hitch.

### BRIEF DESCRIPTION OF THE DRAWINGS

FIG. 1 is a perspective view of a preferred embodiment of the present invention, a cargo carrier.

FIG. 2 shows the cargo carrier of FIG. 1 without the cargo carrying platform.

FIG. 3 shows the hitch member of the cargo carrier of FIG. 1.

FIG. 4 shows the leg brace of the cargo carrier of FIG. 1.

FIG. 5 shows the pin bracket of the cargo carrier of FIG. 1.

FIG. 6 shows a supporting leg of the cargo carrier of FIG. 1.

FIG. 7 shows the supporting leg of FIG. 6 with an attachable wheel member.

FIG. 8 illustrates the wheel member of FIG. 7 attached to the supporting leg.

FIG. 9 shows the hitch pin of the cargo carrier of FIG. 1.

FIG. 10 Illustrates a section view of the hitch pin attached to the pin bracket.

FIG. 11 is a perspective view illustrating a storage unit attachable to the cargo carrier of FIG. 1.

### DESCRIPTION OF THE PREFERRED EMBODIMENT

In accordance with the present invention, a cargo carrier is disclosed. The cargo carrier provides an improved carrier for storing and transporting cargo and the like on the exterior of a vehicle. The cargo carrier of the present invention is attached to a common trailer hitch of the vehicle. Specifically, it will be noted in the drawings that the cargo carrier includes leg extensions that allow the cargo carrier to be stationed on the ground surface when still being attached to the vehicle, and further provides an easily accessible attachment means for connecting the cargo carrier to the towing hitch of the vehicle. In the broadest context, the cargo carrier consists of components configured and correlated with respect to each other so as to attain the desired objective.

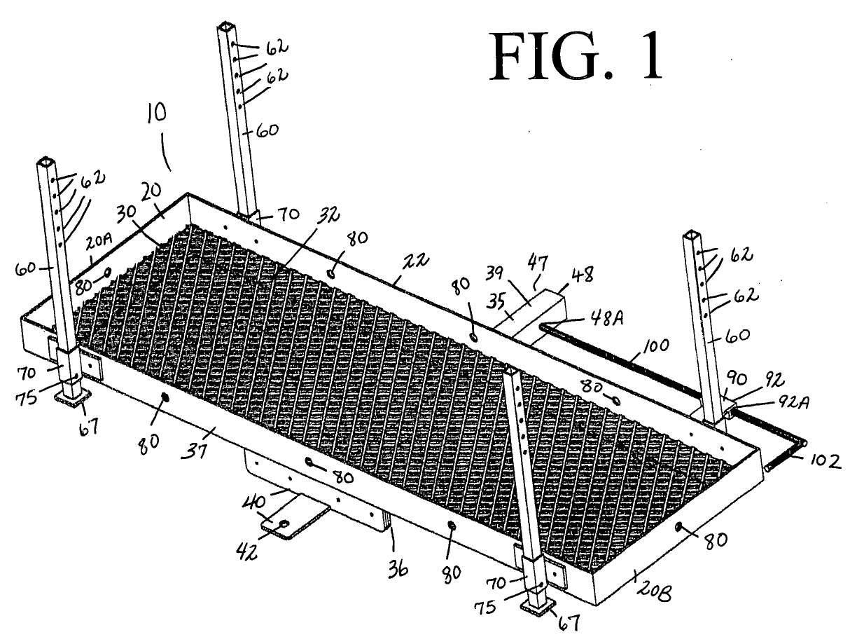

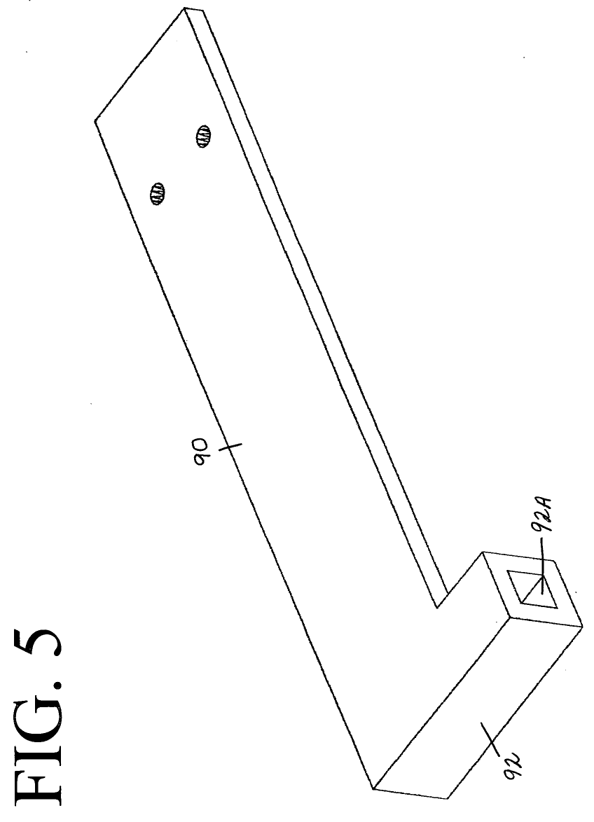

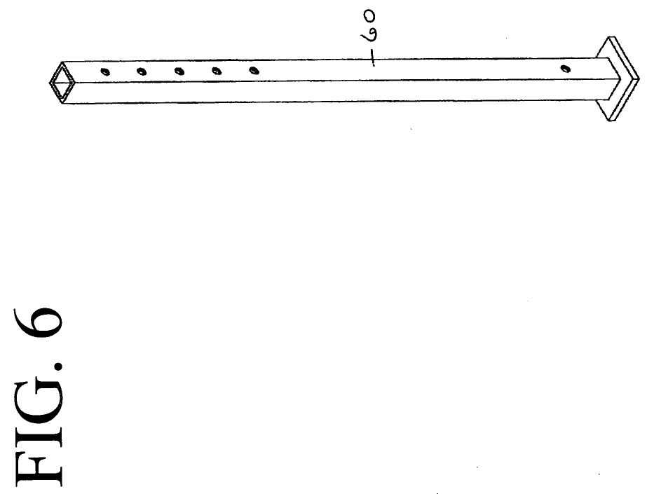

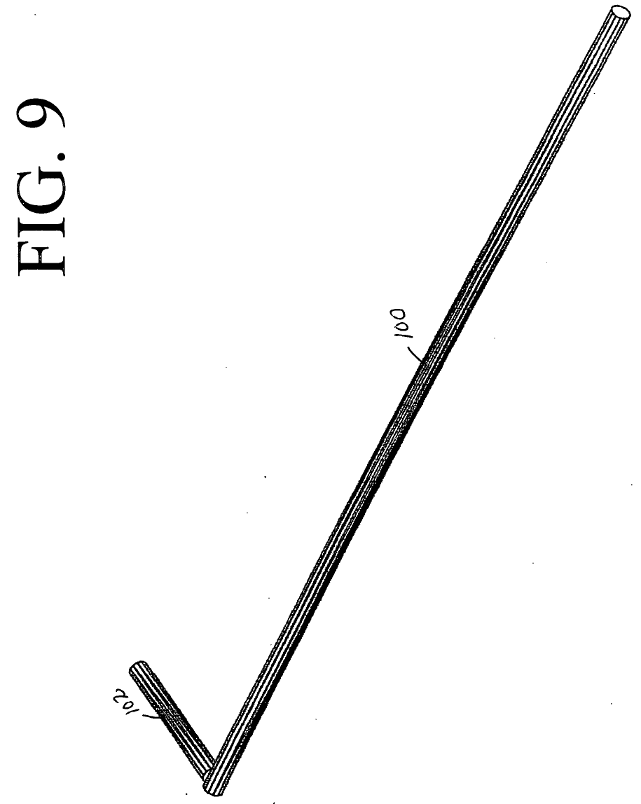

FIGS. 1-11 illustrate a preferred embodiment of a cargo carrier 10 made in accordance of the present invention. As will be described, the cargo carrier 10 is generally for use in storing and transporting luggage, gear, equipment and the like on the exterior of a vehicle (not shown).

The cargo carrier 10 comprises a rectangular-shaped frame 20 having a cargo carrying platform 30. A support member 35 is attached to the under side of the frame 20, and extends parallel with ends 20A and 20B of the frame 20. The support member 35 is provided to give additional structural support for heavy loads to the frame 20. The support member 35 includes a first end 36 that attaches to a rear hitch member 40 with bolts (not shown). The rear hitch member 40 extends from a rear end 37 of the frame 20. The hitch member 40 includes a rear hitch aperture 42. An opposite end 39 of the support member 35 defines a detachable engagement 47 of the carrier 10 for connecting the carrier 10 to a common trailer hitch.

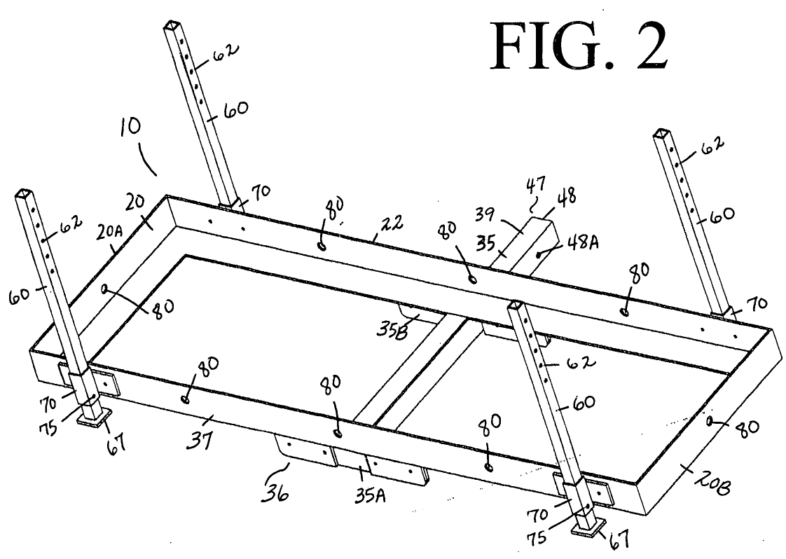

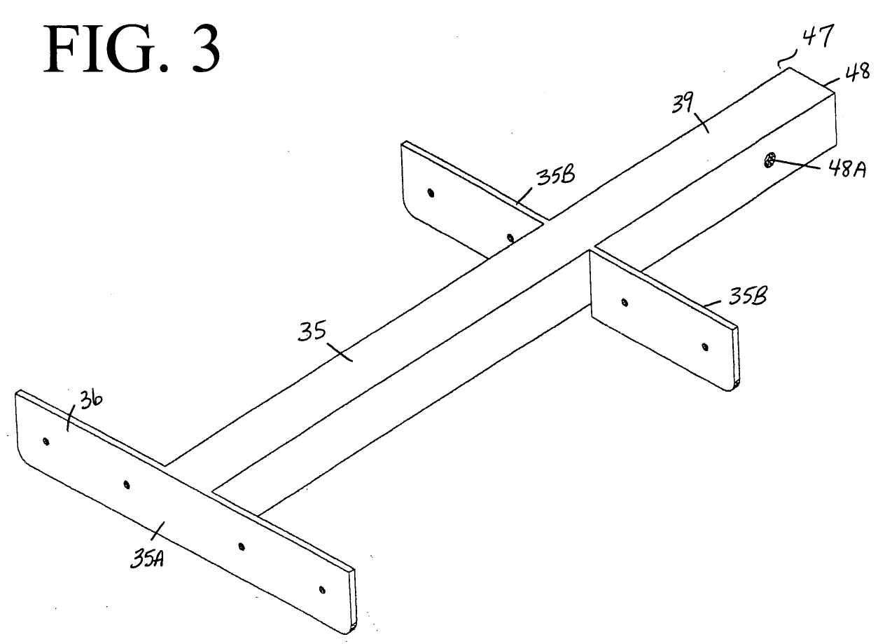

As best shown in FIGS. 2 and 3, the support member 35 further includes a first cross-section 35A and a second cross-section 35B. The first cross-section 35A of the support member 35 attaches to the rear end 37 of the frame 20 with attaching means known in the art. The second cross-section 35B of the support member 35 attaches to a front end 22 of the frame 20 with attaching means known in the art.

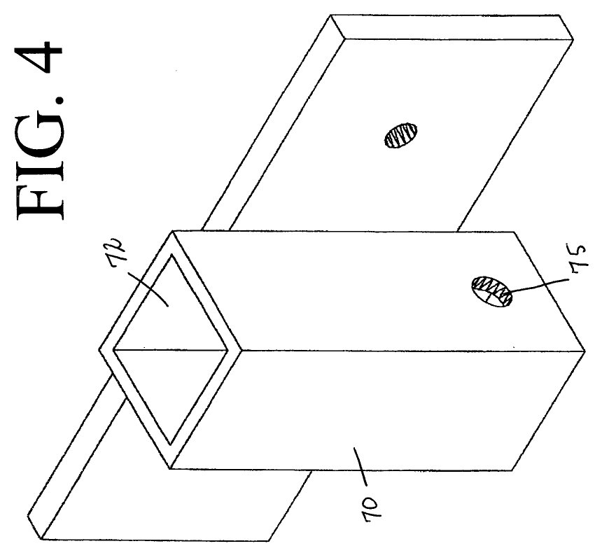

The cargo carrier 10 further comprising supporting legs 60, each supporting leg 60 situated at one of the four corners of the frame 20. A leg brace 70 is further attached adjacent to each corner of the frame 20. The brace 70 including a channel 72 (best shown in FIG. 4) sized to receive the supporting leg 60 as will be further discussed.

The leg brace 70 further including an aperture 75 for receipt of a leg brace pin such as shown in FIG. 8 and designated numeral 73. The supporting leg 60 is preferably a square-section hollow tube that is slidingly positioned through the channel 72, and selectively fastened therein by means of the leg brace pin 73. In particular, the leg brace pin 73 can be introduced into the aperture 75 of the brace 70 and into any of several holes 62 including a lower end hole 64 disposed near a lower base 67 of the leg 60. As will be understood, the lower base 67 is for stabilizing the leg 60 when the cargo carrier 10 is resting on the ground surface. As shown in FIG. 1, the several holes 62 are arranged at an end of the leg brace 60 opposite the lower base 67. As stated, the lower end hole 64 is situated at the end of the brace 60 near or adjacent the lower base 67.

The cargo carrier 10 further includes a plurality of tie down apertures 80 positioned along the ends of the frame 20.

As illustrated in FIGS. 1 and 2, the engagement means 47 extends from the front end 22 of the frame 20. The engagement means 47 includes an engaging portion 48 sized to be slidingly received within a common trailer hitch (not shown). The engaging portion 48 is preferably of tubular construction, having a cross-section of somewhat uniform shape throughout its length. Preferably also, the engaging portion 48 has a square cross-section whose exterior dimensions are slightly smaller than the interior dimensions of the common trailer hitch. As will be described, the engaging portion 48 further includes a side aperture 48A.

A pin bracket 90 is attached to the front end 22 of the frame 20. The pin bracket 90 includes a bracket end 92 having a pin bracket clearance 92A therethrough. In application, and as best shown in FIG. 1, the end bracket 92 is disposed in parallel relationship with the length of the front end 22 of the frame 20. Further as shown in FIG. 1, the pin bracket clearance 92A is in approximate alignment with the side aperture 48A of the engaging portion 48. As shown in FIG. 1, the pin bracket 90 is attached to the front end 22 of the frame 20 adjacent one of the braces 70 disposed on the front end 22.

The cargo carrier 10 further includes an elongated hitch pin 100 having a handle portion 102. In application (shown in FIG. 1), the hitch pin 100 having a length so that the hitch pin 100 passes through the pin bracket clearance 92A of the pin bracket 90 and into the side aperture 48A of the engaging portion 48 of the support member 35. Once received through the pin bracket clearance 92 and into the side aperture 48A, the handle portion 102 of the hitch pin 100 is in approximate alignment with the ends 20A and 20B of the frame 20.

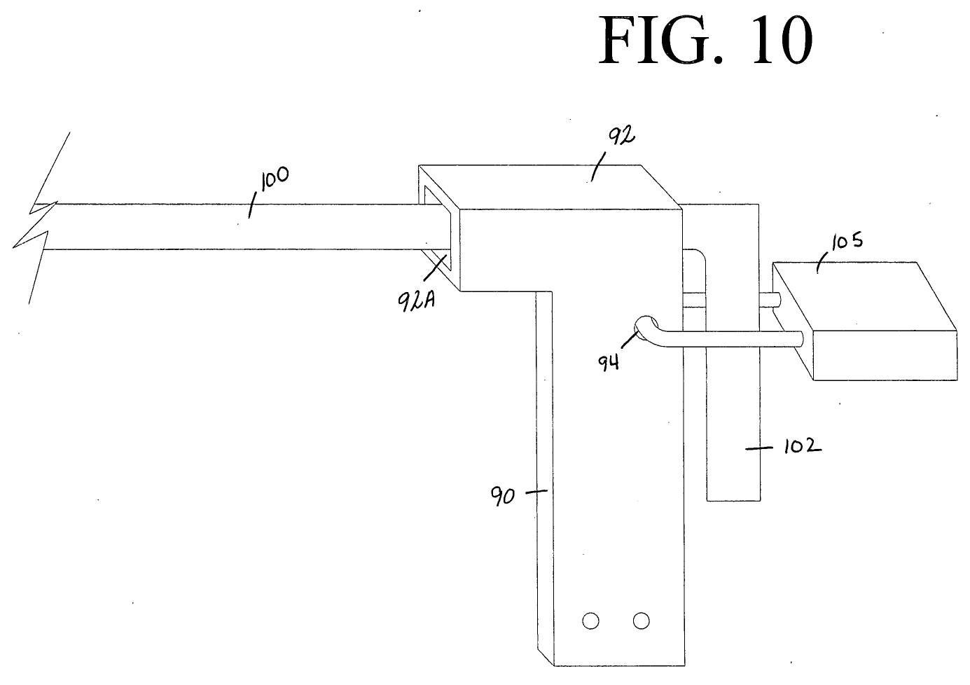

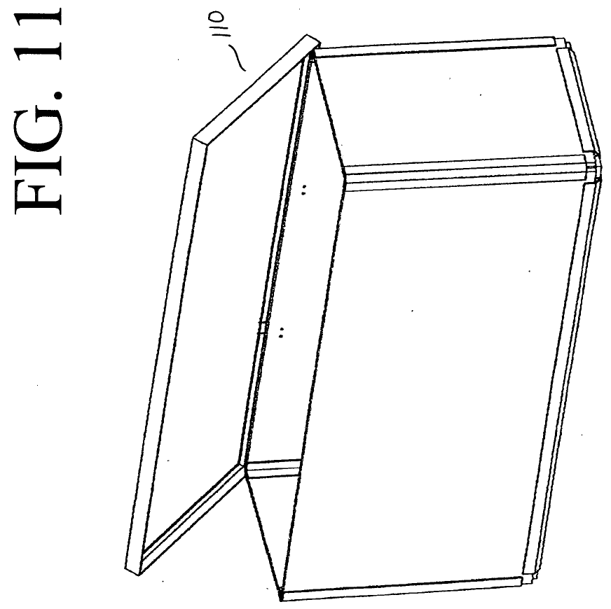

The engagement means 47 can further include a hitch pin retainer 105 preferably attached with an aperture 94 of the pin bracket 90 as shown in FIG. 10. During application, the retainer 105 is an attaching means to releasably retain the hitch pin 100 in place so that the hitch pin 100 will not separate from the pin bracket clearance 92A and side aperture 48A. Obviously, releasing the retainer 105 allows the user to then remove the hitch pin 100 from the pin bracket clearance 92A and side aperture 48A.

The hitch pin retainer 105 is preferably provided so as to prevent the inadvertent or unwanted removal of the hitch pin 100 from the pin bracket clearance 92A and side aperture 48A. The pin bracket end 92 of the pin bracket 90 including the pin bracket clearance 92A, the side aperture 48A of the engagement portion 48, the hitch pin 100, and the hitch pin retainer 105 thereby comprise the engagement means 47 of the cargo carrier 10, and provides a means for retaining the vehicle's trailer hitch in engagement with the cargo carrier 10.

The cargo carrier 10 also preferably includes a cargo storage unit such as shown in FIG. 11 and designated numeral 110 that can be attached to an upper surface 32 of the platform 30. The cargo storage unit 110 is preferably dimensioned so as to extend across substantially all of the platform 30. The cargo carrier 110 is attached to the upper surface 32 of the platform 30 by a means such as a set of straps (not shown) attached to the tie down apertures 80 of the platform 30 and passing over or around the cargo storage unit 110. Other attaching means, such as bolts or the like, can be employed as well.

It should be evident that in application, the cargo carrier 10 can be attached to the vehicle's trailer hitch without the user being required to lie on the ground surface beneath the carrier and/or vehicle in order to access connecting the engaging portion 48 of the carrier 10 to the vehicle's hitch. Instead, the engaging portion 48 is connected or disconnected from the vehicle's hitch by inserting or removing the hitch pin 100 as described from the side of the cargo carrier 10. This obviously avoids the danger exposed to users of prior art in systems that are required to lie on the ground surface beneath either the cargo carrier or vehicle in order to access the hitch system.

Use of the cargo carrier 10 according to the present invention is straight forward. Starting from an engaged position, the hitch pin retainer 105 (when used) is released to unlock the hitch pin 100 from the pin bracket 90. The hitch pin 100 is then slidingly removed from the pin bracket clearance 92A and side aperture 48A. The leg brace pin 73 at each corner of the frame 20 is released and the supporting legs 60 positioned so that the lower base 67 of each leg 60 is resting on the ground surface. The leg brace 10 is then re-inserted through the aperture 75 of the brace 70 and into the selected hole 62 so that the lower base 67 remains resting on the ground surface and stabilizes the leg 60 in contact with the ground surface. With the cargo carrier 10 resting on the ground surface, and the hitch pin 100 removed as discussed above, the vehicle can be driven in a forwardly direction in order to separate the vehicle's trailer hitch from the engaging portion 48 of the cargo carrier 10, and therefore separate the vehicle from the cargo carrier 10. Of course, it may be easier to first position the supporting legs 60 on the ground surface as discussed above, and then unlock the hitch pin 100 as further discussed above. The entire disengagement process of the cargo carrier 10 from the vehicle can be performed in approximately 1 minute or less.

Attachment of the disengaged cargo carrier 10 of the vehicle is similarly straight forward. The engaging portion 48 is slidingly received and connected with the trailer hitch of the vehicle. The hitch pin 100 is inserted through the pin bracket clearance 92A and into the side aperture 48A. The hitch pin 100 can then be placed in locking engagement with the pin bracket 90 by inserting the hitch pin retainer 105. It is important to note that the hitch pin 100 is inserted into the clearance and aperture from an end of the cargo carrier 10 rather than the user being required to lie beneath the cargo carrier 10 and/or vehicle in order to access the trailer hitch. The supporting legs 60 are then positioned for mobility as shown in FIG. 1 by removing the leg brace pin 73, raising the supporting legs 60 so that the lower base 67 is positioned near the brace 70 as shown in FIG. 1 and re-inserting the hitch pin retainer 73 as previously discussed.

Significant advantages arise from the cargo carrier 10 according to the present invention. The cargo carrier 10 is connected solely to the vehicle's trailer hitch with the engaging means 47 as discussed above. In particular, the hitch pin 100 is inserted through the pin bracket clearance 92A and into the side aperture 48A without the user being required to lie beneath the cargo carrier and/or vehicle to attach. Further, no support members or nuts or bolts are required to attach the cargo carrier 10 to the vehicle, other than the hitch pin 100 previously described.

Of course, the cargo carrier 10 of the present invention can be made of larger or smaller dimensions. Both the shape and size of the cargo carrier platform 30 and the storage unit 110 can be varied according to the make or model of vehicle on which the carrier is to be employed, as well as according to the type of cargo which will be carried.

Other advantages are evident as well. Use of the hitch pin 100 means that no tools are required for attaching the cargo carrier 10 to the vehicle. The cargo carrier 10 does not need to connect to either the vehicle body or the vehicle bumper. The cargo carrier 10 of the present invention is employable with a standard trailer hitch. The cargo storage unit 110 is preferably both weatherproof and lockable, so as to protect luggage, cargo and/or valuables. The hitch pin retainer 105 provides additional security to hinder the removal of the cargo carrier 10 from the vehicle. Finally, the platform 30 and cargo storage unit 110 are preferably dimensioned large enough to carry packages, suitcases or merchandise of substantial size.

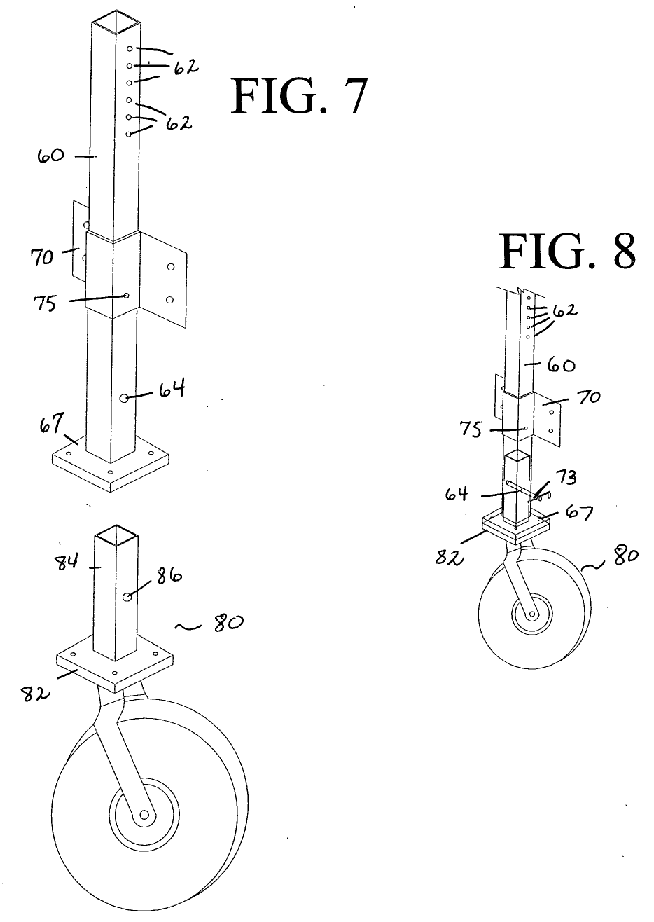

Referring now to FIGS. 7 and 8, the cargo carrier 10 can further include attachable wheel members 80 that attach to the lower base 67 of each supporting leg 60. As will be understood, the wheel members 80 assist in transporting the cargo carrier 10 when not attached to the vehicle. In particular, the wheel member 80 is a common wheel assembly known in the art that includes a flat end 82 and extension member 84 sized and shaped to be received within the supporting leg 60 as shown in FIG. 8. The extension member 84 includes an aperture 86. In application, the extension member 84 is received within the hollow supporting leg 60 and fastened therein by aligning the aperture 86 of the extension member 84 with the lower end hole 64 of the leg 60 and inserting the pin 73 through the apertures 86 and 64.

Although the description above contains many specificities, these should not be construed as limiting the scope of the invention but as merely providing illustrations of some of the presently preferred embodiments of this invention.

It will be obvious to those skilled in the art that modifications may be made to the embodiments described above without departing from the scope of the present invention. Thus the scope of the invention should be determined by the appended claims in the formal application and their legal equivalents, rather than by the examples given.

I claim:

1. A cargo carrier comprising:
a rectangular-shaped frame having a cargo carrying platform,
a support member attached to the underside of the frame, said support member having a first end that defines a rear hitch member and a second end opposite said first end, said second end defining a detachable engagement for connecting the cargo carrier to a trailer hitch,
a leg brace situated at each corner of the frame, said leg brace including a channel sized to slidingly receive a supporting leg, said supporting leg including a plurality of apertures for receipt of a leg brace pin, such that each of said supporting legs can be selectively positioned within the leg brace in relationship to the frame,
a pin bracket attached to a front end of the frame, said pin bracket including a pin bracket clearance in parallel relationship with said front end of the frame such that said pin bracket clearance is in approximate alignment with a side aperture disposed on the second end of said support member, and an elongated hitch pin having a handle portion, said hitch pin having a length such that the hitch pin passes through the pin bracket clearance and into the side aperture.

2. The cargo carrier as recited in claim 1, wherein said pin bracket further includes a hitch pin retainer, said hitch pin retainer includes attachment means in order to retain said hitch pin within said pin bracket clearance and side aperture.

3. The cargo carrier as recited in claim 1, wherein the support member further comprising an engaging portion for connecting the cargo carrier to a common trailer hitch.

4. The cargo carrier as recited in claim 1, wherein said support member further including a first cross-section and a second cross-section, wherein said first cross-section attaches to a rear end of the frame and said second cross-section attaches to said front end of the frame.

5. The cargo carrier as recited in claim 4, wherein said support member is perpendicular to said front end and said rear end of the frame.

6. The cargo carrier as recited in claim 1, wherein said supporting leg including a lower base, wherein at least one of said plurality of apertures is disposed adjacent said lower base.

7. The cargo carrier as recited in claim 1, further including a storage unit attachable to an upper surface of said platform.

8. The cargo carrier as recited in claim 7, wherein said storage unit is attached to said platform with straps.

9. The cargo carrier as recited in claim 8, wherein said straps are attached to at least two tie down apertures disposed in the platform.

10. A cargo carrier comprising:
a frame having a cargo carrying platform,
a support member attached to the underside of the frame, said support member having a first end that defines a rear hitch member and a second end opposite said first end, said second end defining a detachable engagement for connecting the cargo carrier to a trailer hitch,
a pin bracket attached to a front end of the frame, said pin bracket including a pin bracket clearance in parallel relationship with said front end of the frame such that said pin bracket clearance is in approximate alignment with a side aperture disposed on the second end of said support member, and an elongated hitch pin having a handle portion, said hitch pin having a length such that the hitch pin passes through the pin bracket clearance and into the side aperture.

11. The cargo carrier as recited in claim 10, wherein said frame having a rectangular configuration.

12. The cargo carrier as recited in claim 11, further including a leg brace situated at each corner of the frame, said leg brace including a channel sized to slidingly receive a supporting leg, said supporting leg including a plurality of apertures for receipt of a leg brace pin, such that each of said supporting legs can be selectively positioned within the leg brace in relationship to the frame.

13. The cargo carrier as recited in claim 10, wherein said pin bracket further includes a hitch pin retainer, said hitch pin retainer includes attachment means in order to retain said hitch pin within said pin bracket clearance and side aperture.

14. The cargo carrier as recited in claim 10, wherein the support member further comprising an engaging portion for connecting the cargo carrier to a common trailer hitch.

15. The cargo carrier as recited in claim 10, wherein said support member further including a first cross-section and a second cross-section, wherein said first cross-section attaches to a rear end of the frame and said second cross-section attaches to said front end of the frame.

16. The cargo carrier as recited in claim 12, wherein said supporting leg including a lower base, wherein at least one of said plurality of apertures is disposed adjacent said lower base.

17. The cargo carrier as recited in claim 10, further including a storage unit attachable to an upper surface of said platform.

18. The cargo carrier as recited in claim 17, wherein said storage unit is attached to said platform with straps.

19. The cargo carrier as recited in claim 18, wherein said straps are attached to at least two tie down apertures disposed in the platform.

20. The cargo carrier as recited in claim 10, wherein said support member having an L-shaped configuration.
